(19) United States
(12) Patent Application Publication
(10) Pub. No.: US 2024/0142080 A1
(43) Pub. Date: May 2, 2024

(54) OUTDOOR DECORATIVE LAMP

(71) Applicant: DONGGUAN HUIHUAN LIGHTING CO., LTD, Dongguan (CN)

(72) Inventor: Song Wang, Chengdu (CN)

(21) Appl. No.: 18/404,803

(22) Filed: Jan. 4, 2024

(30) Foreign Application Priority Data
Dec. 20, 2023 (CN) 202323471374.5

(51) Int. Cl. F21V 1/12

(52) U.S. Cl. CPC F21V 1/12; F21Y 2115/10

(57) ABSTRACT

The present disclosure relates to the technical field of lamps, and discloses an outdoor decorative lamp, including a lamp holder and a lampshade connected to the lamp holder, and further including a lampwick component and a decorative shell, an annular connecting port is arranged at a top of the accommodating cavity; and the lamp holder extends out of the accommodating cavity through the annular connecting port. In the present invention, a traditional integrated barn lantern lamp is transformed into a replaceable barn lantern lamp bulb by assembling and combining a lamp bulb with the decorative shell. Lamps on a barn lantern string can be replaced at any time, which significantly reduces the usage cost.

### TECHNICAL FIELD

The present disclosure relates to the technical field of lamps, and in particular, to an outdoor decorative lamp.

### BACKGROUND

A traditional barn lantern is a kerosene lamp that can be carried in a hand and protected from wind and rainwater. This lamp can be hung on a horse during night riding, hence obtaining its name. With the development of technology, although the kerosene lamps have gradually been replaced by energy-saving and environmentally-friendly light-emitting diode (LED) lamps, the shape of the barn lantern is still widely circulated, and LED decorative light strings made in the shape of barn lantern are used for courtyard decoration.

The existing decorative barn lantern string is composed of a power cable and several lamps connected in series on the power cable. Connection between the lamps and the power cable is achieved as follows: A two-level core wire inside the power cable extends outwards to be connected to LED luminous sources, and then decorative barn lantern shells are directly integrally molded outside to form barn lantern lamps connected to the power cable. However, the lamps cannot be replaced. If one lamp is damaged, the entire string is scrapped, resulting in high usage costs. In view of this, the inventor has made a new invention.

### SUMMARY

The present disclosure aims to provide an outdoor decorative lamp for the shortcomings in the prior art. The outdoor decorative lamp has the characteristics of low usage cost.

In order to achieve the above objectives, the present disclosure provides an outdoor decorative lamp, including a lamp holder and a lampshade connected to the lamp holder, and further including a lampwick component and a decorative shell, wherein the lampwick component is connected to the lamp holder and extends into the lampshade; the lampwick component includes a first conductive core wire, an LED luminescent lamp body, and a second conductive core wire which are connected in sequence; the decorative shell includes a first shell body and a second shell body; the first shell body and the second shell body are connected to each other to form a circular accommodating cavity; the lampshade is arranged in the accommodating cavity; an annular connecting port is arranged at a top of the accommodating cavity; and the lamp holder extends out of the annular connecting port.

Further, a side wall of the accommodating cavity is hollowed out; and the side wall of the accommodating cavity is provided with an annular limiting frame.

Preferably, a plurality of connecting columns are uniformly arranged on two side walls of the first shell body, and connecting holes are arranged at positions, corresponding to the connecting columns, on the second shell body.

Further, the first shell body and the second shell body are ultrasonically welded or bonded.

Much further, the decorative shell is in a shape of a barn lantern.

Preferably, a lamp base is arranged at a lower end of the decorative shell, and the lamp base is provided with an accommodating position.

Preferably, an assembling part is arranged at an upper end of the lampshade, and the assembling part abuts against the annular connecting port.

Further, the LED luminescent lamp body includes a printed circuit board (PCB) and an integrated circuit (IC) drive controller arranged on the PCB; the PCB has at least one elongated light source integration part extending into the lampshade; the light source integration part is provided with two light-emitting chip groups on at least one side surface; the PCB is printed with a conductive pattern; the IC drive controller is electrically connected to the light-emitting chip groups through the conductive pattern and turns on cyclically the light-emitting chip groups in sequence; and the first conductive core wire and the second conductive core wire are both electrically connected to the IC drive controller.

Further, the PCB is further provided with a supporting part; the IC drive controller is arranged at the supporting part; and the PCB is further provided with an outer packaging layer configured to package the light-emitting chip groups and the IC drive controller.

Preferably, the lampwick component further includes a sealant seat; the sealant seat is in close fit with an opening part of the lampshade; and the sealant seat is provided with at least two accommodating holes for allowing the conductive core wires to pass through.

Beneficial effects: Compared with the prior art, the outdoor decorative lamp of the present disclosure, which includes the lamp holder and the lampshade connected to the lamp holder, and further includes the lampwick component and the decorative shell, has the following advantages: 1. The outdoor decorative lamp can be replaced for use, which can significantly reduce the usage cost of the lamp and prolong the service life of a light string. 2. The outdoor decorative lamp has a beautiful appearance and small volume, can achieve a flowing type light effect, and has high decorativeness. 3. The outdoor decorative lamp has a simple and novel overall structure and low preparation cost.

### BRIEF DESCRIPTION OF THE DRAWINGS

FIG. 1 is a schematic diagram of a three-dimensional structure according to the present disclosure.

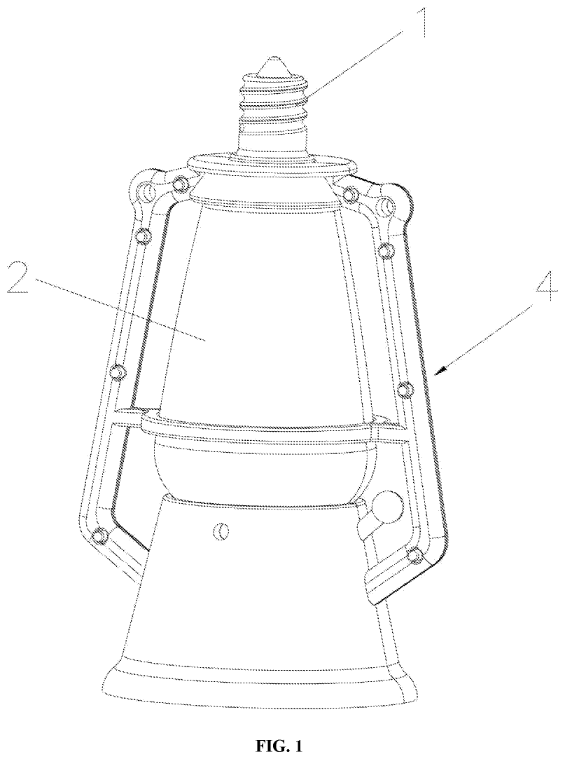

FIG. 2 is a schematic diagram of an exploded structure according to the present disclosure.

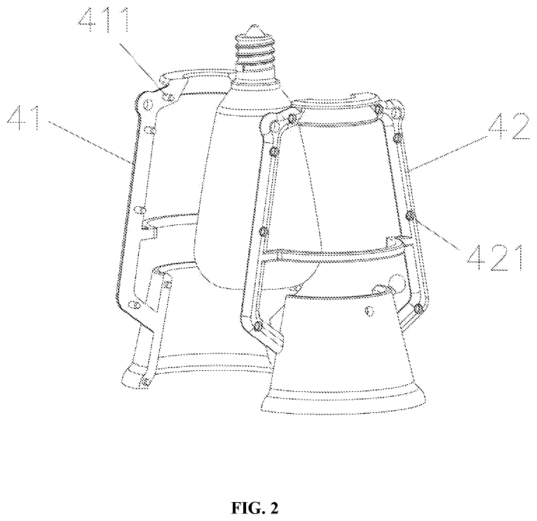

FIG. 3 is a schematic structural diagram of a decorative shell according to the present disclosure.

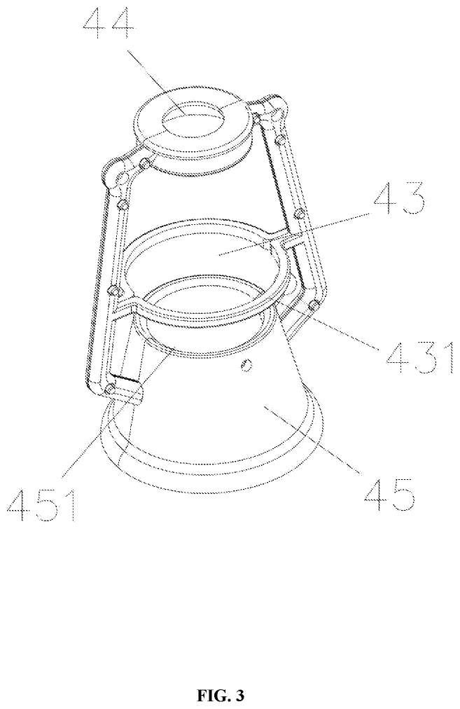

FIG. 4 is a schematic structural diagram of a combination of a lamp holder and a lampshade according to the present disclosure.

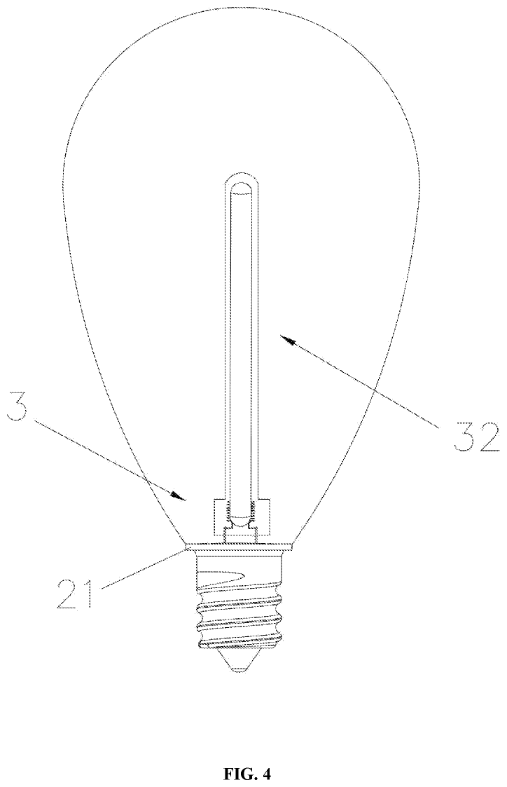

FIG. 5 is a schematic structural diagram of a lampwick component according to the present disclosure.

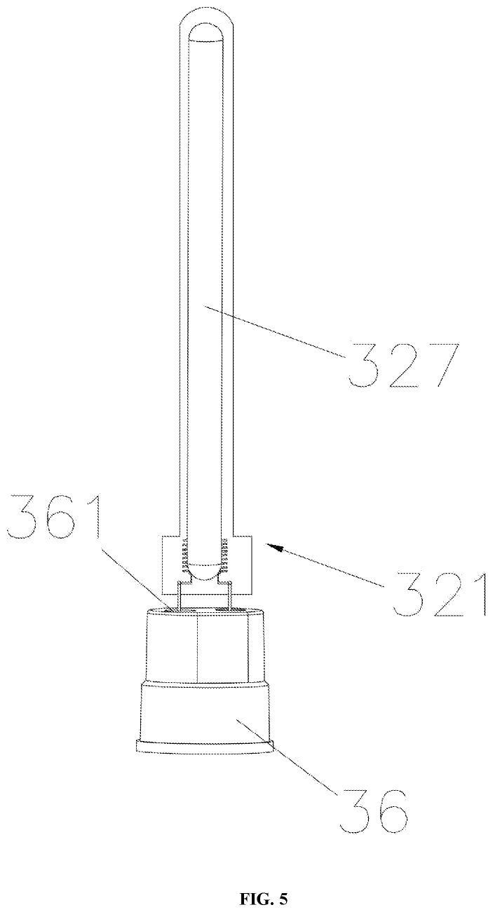

FIG. 6 is a schematic structural diagram of a PCB light source panel according to the present disclosure.

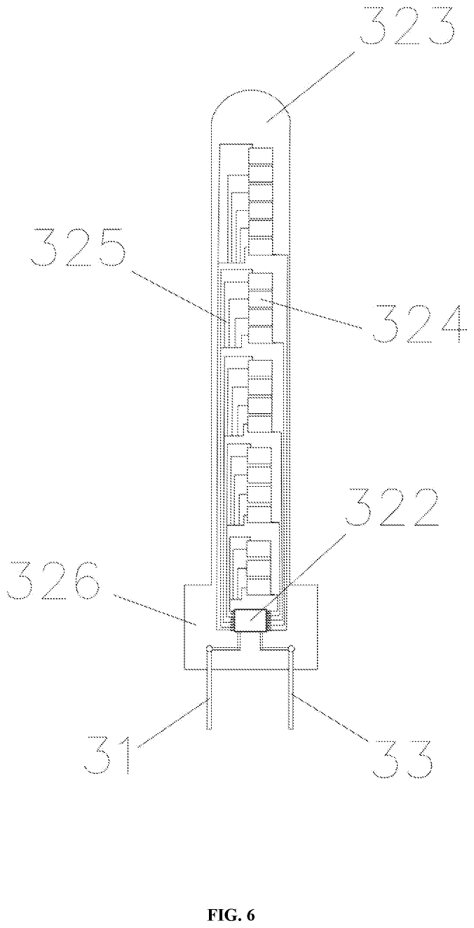

Reference numerals include:

1: lamp holder; 2: lampshade; 21: assembling part; 3: lampwick component; 31: first conductive core wire; 32: LED luminescent lamp body; 321: PCB; 322: IC drive controller; 323: light source integration part; 324: light-emitting chip group; 325: conductive pattern; 326: supporting part; 327: outer packaging layer; 33: second conductive core wire; 36: sealant seat; 361: accommodating hole; 4: decorative shell; 41: first shell body; 411: connecting column; 42: second shell body; 421: connecting hole; 43: accommodating cavity; 431: annular limiting frame; 44: annular connecting port; 45: lamp base; and 451: accommodating position.

### DETAILED DESCRIPTION OF THE EMBODIMENTS

The present disclosure will be explained below in conjunction with the accompanying drawings 1 to 6.

The present disclosure provides an outdoor decorative lamp, including a lamp holder 1 and a lampshade 2 connected to the lamp holder 1. The lampshade 2 is made of a light-transmittance material. The outdoor decorative lamp further includes a lampwick component 3 and a decorative shell 4. The lampwick component 3 is connected to the lamp holder 1 and extends into the lampshade 2. The lampwick component 3 includes a first conductive core wire 31, an LED luminescent lamp body 32, and a second conductive core wire 33 which are connected in sequence. The LED luminescent lamp body 32 extends into the lampshade 2 and is configured to generate a light effect. The first conductive core wire and the second conductive core wire 33 are respectively connected to two ends of the LED luminescent lamp body 32 and used as two poles of a power supply, which are electrically connected to the lamp holder 1 respectively. The decorative shell 4 includes a first shell body 41 and a second shell body 42; the first shell body 41 and the second shell body 42 are connected to each other to form a circular accommodating cavity 43; the lampshade 2 is arranged in the accommodating cavity 43, so that the decorative shell 4 sleeves the lampshade 2 to form a barn lantern lamp; an annular connecting port 44 is arranged at a top of the accommodating cavity 43; and the lamp holder 1 extends out of the annular connecting port 44 to be connected to an external lamp base 45.

In order to reduce the usage cost of the existing LED barn lantern string, a lamp bulb and the decorative shell 4 are assembled to transform an existing integrated barn lantern lamp into a replaceable barn lantern lamp. The lamp can be electrically connected to the external lamp base by using the threaded lamp holder 1 with an exposed top end. When a certain lamp fails, after the lamp is removed to replace a new lamp, the string can be used again. This significantly reduces the usage cost of a decorative light string and prolongs the service life of the decorative light string. On the other hand, on the basis of the ability of simulating the shape of a barn lantern, the lamp has a simple overall structure. This lamp is only formed by combining the lamp bulb with the decorative shell 4, and the decorative shell 4 is formed in a split type. During the assembling of the lamp, the two shell bodies of the decorative shell 4 are aligned with an assembling position of the lampshade 2 and are directly buckled to form the lamp. The assembling process is simple and efficient, and can reduce the preparation cost of the lamp.

As an embodiment, a side wall of the accommodating cavity 43 is hollowed out. The accommodating cavity 43 simulates a shape of a barn lantern by directly relying on the lampshade 2, instead of adding a transparent shell on the decorative shell 4, so that the preparation cost is further reduced. In a further optimized technical solution, the side wall of the accommodating cavity 43 is provided with an annular limiting frame 431. During use, the annular limiting frame 431 abuts against an exterior of a side wall of the lampshade 2 to limit the position of the lamp base 45, which can prevent the lampshade 2 from being separated from the decorative shell 4.

As an embodiment, a plurality of connecting columns 411 are uniformly arranged on two side walls of the first shell body 41, and connecting holes 421 are arranged at positions, corresponding to the connecting columns 411, on the second shell body 42. The first shell body 41 and the second shell body 42 are assembled and formed by connecting the connecting columns 411 to the connecting holes 421. This connection method is convenient for assembling and has high efficiency. Both the connecting columns 411 and the connecting holes 421 can be formed together during the formation of the shell bodies, without requiring additional process steps. Meanwhile, after the shell bodies are connected, they can also be disassembled, so that the decorative shell 4 is recyclable, which further reduces the usage cost of the lamp.

As another embodiment, the first shell body 41 and the second shell body 42 are ultrasonically welded or bonded. Whether they are ultrasonically welded or bonded and formed by glue, the two shell bodies of the decorative shell 4 has higher connection strength.

In this technical solution, the decorative shell 4 is in a shape of a barn lantern. After the decorative shell 4 sleeves the lampshade 2, a decoration effect of the traditional barn lantern can be simulated, so that the lamp has higher decorativeness.

Preferably, a lamp base 45 is arranged at a lower end of the decorative shell, and the lamp base 45 is provided with an accommodating position 451. After the lampshade 2 is placed into the accommodating cavity 43, a bottom end can adapt to the accommodating position 451 to fix the bottom end of the lampshade 2.

Further, an assembling part 21 is arranged at an upper end of the lampshade 2, and the assembling part 21 abuts against the annular connecting port 44 to fix the upper end of the lampshade 2.

In this technical solution, the LED luminescent lamp body 32 includes a PCB 321 and an IC drive controller 322 arranged on the PCB 321; the PCB 321 has at least one elongated light source integration part 323 extending into the lampshade 2; the light source integration part 323 is provided with two light-emitting chip groups 324 on at least one side surface; the PCB 321 is printed with a conductive pattern 325; the IC drive controller 322 is electrically connected to the light-emitting chip groups 324 through the conductive pattern 325 and turns on cyclically the light-emitting chip groups 324 in sequence; and the first conductive core wire 31 and the second conductive core wire 33 are both electrically connected to the IC drive controller 322. When the lampwick component of the present invention is powered on for use, a current flows through the IC drive controller 322 through the first conductive core wire 31, and then the IC drive controller 322 controls the current to be transferred to the plurality of light-emitting chip groups 324 in sequence, so that the light-emitting chip groups 324 are turned on or turned off in sequence along a layout direction, forming a flowing type light effect. When the lampwick component is stopped, the current flows back through the second conductive core wire 33.

In addition to greatly reducing the usage cost of the LED barn lantern string, the present invention also improves the structure of the lampwick component 3. The light-emitting chip groups 324 are integrated into the light source integration part 323 to form a lampwick with the flowing type light effect. Cooperative use with the barn lantern shell further improves the decoration effect. Meanwhile, the flowing type lamp has the advantages of small volume, low cost, convenience of use, and the like.

Further, the PCB 321 is further provided with a supporting part 326, and the IC drive controller 322 is arranged on the supporting part 326. A width of the supporting part 326 should be greater than a width of the light source integration part 323, thereby reserving an enough space to assemble the IC drive controller 322 and achieving welding to the conductive core wires. On the other hand, the PCB 321 is further provided with an outer packaging layer 327 configured to package the light-emitting chip groups 324 and the IC drive controller 322. The outer packaging layer 327 ensures that the conductive pattern 325 between the light-emitting chip groups 324 and the IC drive controller 322 is not easily damaged during assembling, which effectively prolongs the service life of a lamp bulb. On the other hand, the outer packaging layer 327 can also improve the aesthetics of the light source integration part 323, thereby improving the aesthetics of the lamp bulb. A material of the outer packaging layer 327 is epoxy resin, polyurethane modified epoxy resin, or polyurethane resin. These materials have the advantages of high-temperature resistance, good toughness, no irritating odor, and the like.

Preferably, the lampwick component 3 further includes a sealant seat 36; the sealant seat 36 is in close fit with an opening part of the lampshade 2; and the sealant seat 36 is provided with at least two accommodating holes 361 for allowing the conductive core wires to pass through. The sealant seat 36 can provide a supporting force for the LED luminescent lamp body 32 to stably arrange the LED luminescent lamp body inside the lampshade 2, and can also seal the opening part position of the lampshade 2 to improve the waterproof performance of the lampshade 2.

The above content only describes preferred embodiments of the present disclosure. A person of ordinary skill in the art can make changes to specific implementations and the application scope according to the idea of the present disclosure. The content of this specification should not be understood as a limitation on the present disclosure.

What is claimed is:

1. An outdoor decorative lamp, comprising a lamp holder (1) and a lampshade (2) connected to the lamp holder (1), and further comprising a lampwick component (3) and a decorative shell (4), wherein the lampwick component (3) is connected to the lamp holder (1) and extends into the lampshade (2); the lampwick component (3) comprises a first conductive core wire (31), a light-emitting diode (LED) luminescent lamp body (32), and a second conductive core wire (33) which are connected in sequence; the decorative shell (4) comprises a first shell body (41) and a second shell body (42); the first shell body (41) and the second shell body (42) are connected to each other to form a circular accommodating cavity (43); the lampshade (2) is arranged in the accommodating cavity (43); an annular connecting port (44) is arranged at a top of the accommodating cavity (43); and the lamp holder (1) extends out of the annular connecting port (44).

2. The outdoor decorative lamp according to claim 1, wherein a side wall of the accommodating cavity (43) is hollowed out; and the side wall of the accommodating cavity (43) is provided with an annular limiting frame (431).

3. The outdoor decorative lamp according to claim 1, wherein a plurality of connecting columns (411) are uniformly arranged on two side walls of the first shell body (41), and connecting holes (421) are arranged at positions, corresponding to the connecting columns (411), on the second shell body (42).

4. The outdoor decorative lamp according to claim 1, wherein the first shell body (41) and the second shell body (42) are ultrasonically welded or bonded.

5. The outdoor decorative lamp according to claim 1, wherein the decorative shell (4) is in a shape of a barn lantern.

6. The outdoor decorative lamp according to claim 1, wherein a lamp base (45) is arranged at a lower end of the decorative shell (4), and the lamp base (45) is provided with an accommodating position (451).

7. The outdoor decorative lamp according to claim 1, wherein an assembling part (21) is arranged at an upper end of the lampshade (2), and the assembling part (21) abuts against the annular connecting port (44).

8. The outdoor decorative lamp according to claim 1, wherein the LED luminescent lamp body (32) comprises a printed circuit board (PCB) (321) and an integrated circuit (IC) drive controller (322) arranged on the PCB (321); the PCB (321) has at least one elongated light source integration part (323) extending into the lampshade (2); the light source integration part (323) is provided with two light-emitting chip groups (324) on at least one side surface; the PCB (321) is printed with a conductive pattern (325); the IC drive controller (322) is electrically connected to the light-emitting chip groups (324) through the conductive pattern (325) and turns on cyclically the light-emitting chip groups (324) in sequence; and the first conductive core wire (31) and the second conductive core wire (33) are both electrically connected to the IC drive controller (322).

9. The outdoor decorative lamp according to claim 8, wherein the PCB (321) is further provided with a supporting part (326); the IC drive controller (322) is arranged at the supporting part (326); and the PCB (321) is further provided with an outer packaging layer (327) configured to package the light-emitting chip groups (324) and the IC drive controller (322).

10. The outdoor decorative lamp according to claim 1, wherein the lampwick component (3) further comprises a sealant seat (36); the sealant seat (36) is in close fit with an opening part of the lampshade (2); and the sealant seat (36) is provided with at least two accommodating holes (361) for allowing the conductive core wires to pass through.
